(19) United States
(12) Patent Application Publication
(10) Pub. No.: US 2015/0341698 A1
(43) Pub. Date: Nov. 26, 2015

(54) METHOD AND DEVICE FOR PROVIDING SELECTION OF VIDEO

(71) Applicant: Xiaomi Inc., Beijing (CN)

(72) Inventors: Li Tian, Beijing (CN); Zhen Dong, Beijing (CN); Bainan Wang, Beijing (CN); Chao Liu, Beijing (CN)

(21) Appl. No.: 14/585,213

(22) Filed: Dec. 30, 2014

Related U.S. Application Data
(63) Continuation of application No. PCT/CN2014/089254, filed on Oct. 23, 2014.

(30) Foreign Application Priority Data
May 20, 2014 (CN) 201410213476.3

(51) Int. Cl. H04N 21/482

(52) U.S. Cl. CPC H04N 21/482

(57) ABSTRACT

Provided are a method and a device for providing a selection of video, which belong to the field of Internet technology. The method comprises: for an arbitrary video, acquiring a characteristic identification of the video; determining m videos with the same characteristic identification, which includes at least two types of videos, where m≧2, wherein the at least two types of videos comprise any two or all of types of online video, offline video, and live video; and providing a list of the selection of video according to the m videos. Problems in the related art, that playing and selecting of only a single type of multi-episode video, switching between different types of videos requiring a large amounts of additional operations and influencing of video fluency when a user views the video, may be solved.

### CROSS-REFERENCE TO RELATED APPLICATIONS

This application is a Continuation Application of International Application No. PCT/CN2014/089254, filed on Oct. 23, 2014, which is based upon and claims priority to Chinese Patent Application No. 201410213476.3, filed on May 20, 2014, the entire contents of which are incorporated herein by reference.

### TECHNICAL FIELD

The present disclosure generally relates to the field of Internet technology, and more particularly, to a method and a device for providing a selection of video.

### BACKGROUND

With the continuous development of Internet technology, a video player, in addition to providing a basic function of video playback, still needs to provide more auxiliary functions, such as the selection of video, continuous playback or video recommendation, and the likes.

According to different video resources, the video played by the video player can be roughly divided into the following three types: online video, offline video and live video. Among them, the online video refers to a video which is viewed by a user through access to the Internet, the offline video refers to a video which is viewed by the user without access to the Internet and may be obtained by downloading and storing an online video, and the live video refers to a video which is played in real time, such as live television broadcast and live Internet broadcast. The video player can provide a list of episodes for the user to select when playing multi-episode online videos, wherein the list of episodes contains a part or all of the episodes currently played, and the episodes contained in the list of episodes are also online videos. Similarly, the video player can provide a list of episodes for the user to select while playing multi-episode offline videos, wherein the list of episodes contains a part or all of the episodes of the current played, and the episodes contained in the list of episodes are also offline videos. The video player usually provides a broadcast schedule of the current channel for the user to replay the already played live video and/or preview a live video yet to be broadcasted, while playing a live video, the video player does not provide the other episodes of the currently played live video.

### SUMMARY

According to a first aspect of embodiments of the present disclosure, a method of providing a selection of video is provided, which includes: for an arbitrary video, acquiring a characteristic identification of the video; determining m videos with the same characteristic identification, which includes at least two types of videos, where m≧2, wherein the at least two types of videos comprise any two or all of types of online video, offline video, and live video; and providing a list of the selection of video according to the m videos.

According to a second aspect of embodiments of the present disclosure, a devices of providing a selection of video is provided which includes: a processor; a memory for storing instructions executable by the processor; wherein, the processor is configured to perform: for an arbitrary video, acquiring a characteristic identification of the video; determining m videos with the same characteristic identification, which includes at least two types of videos, where m≧2, wherein the at least two types of videos comprise any two or all of types of online video, offline video, and live video; and providing a list of the selection of video according to the m videos.

According to a third aspect of embodiments of the present disclosure, a non-transitory computer-readable storage medium having stored therein instructions that, when executed by a processor of a device, causes the device to perform a method of providing a selection of video, the method comprising: for an arbitrary video, acquiring a characteristic identification of the video; determining m videos with the same characteristic identification, which includes at least two types of videos, where m≧2, wherein the at least two types of videos comprise any two or all of types of online video, offline video, and live video; and providing a list of the selection of video according to the m videos.

The technical solutions provided by the embodiments of the present disclosure have the following advantages.

Accordingly, by acquiring the characteristic identification of the arbitrary video, determining the m videos with the same characteristic identification of the at least two types of videos, and providing the list of the selection of video according to the m videos, where the at least two types including any two or all of online video, offline video, and live video, problems in the related art, that playing and selecting of only a single type of multi-episode video, switching between different types of videos requiring a large amounts of additional operations and influencing of video fluency when a user views the video, may be solved. It can be realized that in the list of the selection of video, the function of selecting episodes of the at least two types of videos including online video, offline video and live video, may be provided, so that switching and selecting between different types of videos may become simpler and more convenient, thereby improving video fluency when a user views the video.

It should be understood that, the general description above and the detailed description below are merely exemplary, and do not limit the disclosure.

### BRIEF DESCRIPTION OF THE DRAWINGS

The accompanying drawings, which are incorporated in and constitute a part of this specification, illustrate the embodiments according to the present disclosure, and serve as explaining the principles of the present disclosure together with the description.

FIG. 1 is a flowchart of a method for providing a selection of video according to an exemplary embodiment;

FIG. 2A is a flowchart of another method for providing a selection of video according to an exemplary embodiment;

FIG. 2B is a view showing an interface interaction view related to the present embodiment;

FIG. 3 is a block diagram of an apparatus for providing a selection of video according to an exemplary embodiment;

FIG. 4 is a block diagram of another apparatus for providing a selection of video according to an exemplary embodiment; and

FIG. 5 is a block diagram of a device according to an exemplary embodiment.

Through the above accompany drawings, the specific embodiments of the disclosure have been shown, for which a more detailed description will be given as below. These drawings and textual description are not intended to limit the scope of the concept of the disclosure in any manner, but to explain the concept of the disclosure to those skilled in the art through particular embodiments.

### DETAILED DESCRIPTION

Herein, the exemplary embodiments will be described in detail, the examples of which are illustrated in the appended drawings. When the following description involves the appended drawings, the same reference number in the appended drawings illustrates the same or similar elements, unless otherwise. The implementation described in the following exemplary embodiments does not mean all the implementation consistent with the present disclosure. Rather, they are only examples of methods and apparatuses consistent with some aspects of the present disclosure detailed in the enclosed claims.

In respective embodiments of the present disclosure, a video player may be a software program with a function of playing a video as well as an electronic device with a function of playing a video. When the video player is a software program with a function of playing a video, the software program runs in an electronic device.

In addition, the above electronic device may be generally a smart mobile phone, a tablet PC, a smart television, an ebook reader, a Moving Picture Experts Group Audio Layer III (MP3) player, a Moving Picture Experts Group Audio Layer IV (MP4) player, a laptop portable computer, a desktop computer, and a smart TV, or the like.

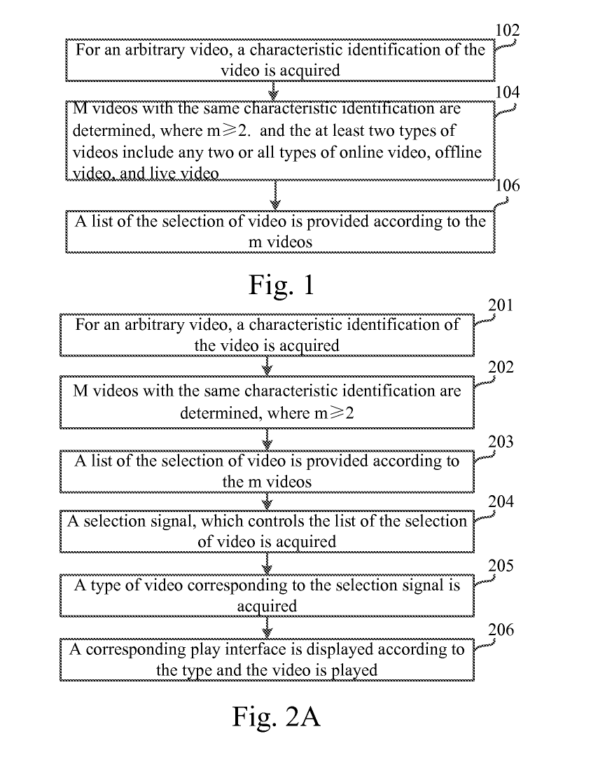

FIG. 1 is a flowchart of a method for providing a selection of video according to an exemplary embodiment. This embodiment takes the method for providing video selection which is applied in a video player for example. The method for providing the selection of video may include the following steps.

In step 102, for an arbitrary video, a characteristic identification of the video is acquired.

In step 104, m videos with the same characteristic identification, which includes at least two types of videos, are determined, where m≧2 and the at least two types of videos include any two or all types of online video, offline video, and live video.

In step 106, a list of the selection of video is provided according to the m videos.

Accordingly, in the method for providing the selection of video, by acquiring the characteristic identification of the arbitrary video, determining the m videos with the same characteristic identification, which includes the at least two types of videos, and providing the list of the selection of video according to the m videos, where the at least two types including any two or all of online video, offline video, and live video, problems in the related art, that playing and selecting of only a single type of multi-episode video, switching between different types of videos requiring a large amounts of additional operations and influencing of video fluency when a user views the video, may be solved. It can be realized that in the list of the selection of video, the function of selecting episodes of the at least two types of videos including online video, offline video and live video, may be provided, so that switching and selecting between different types of videos may become simpler and more convenient, thereby improving video fluency when a user views the video.

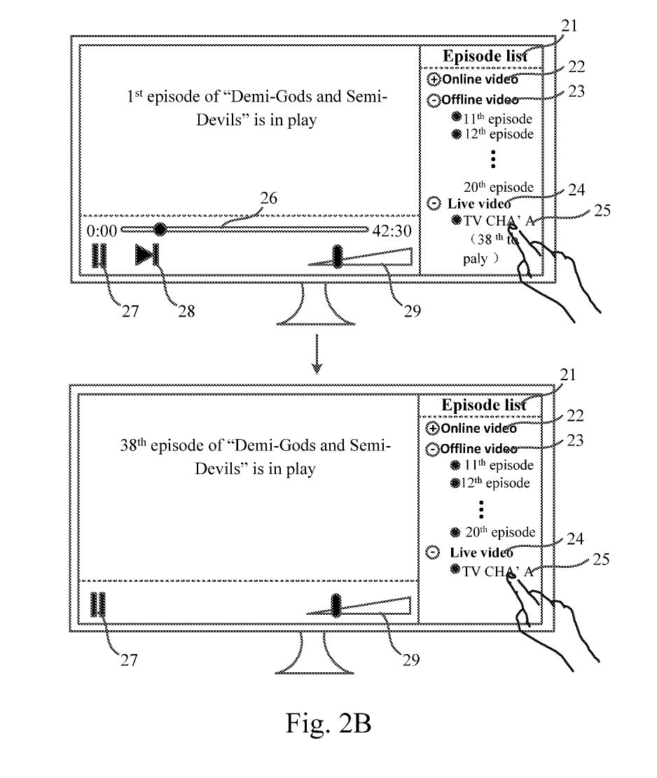

FIG. 2A is a flowchart of another method for providing a selection of video according to an exemplary embodiment. This embodiment takes the method for providing video selection which is applied in a video player for example. The method for providing the selection of video may include the following steps.

In step 201, for an arbitrary video, a characteristic identification of the video is acquired.

When a user selects and plays the arbitrary video, the video player acquires the characteristic identification of the video. Herein, the characteristic identification is used for identifying different video programs. As for a multi-episode video, different episodes correspond to the same characteristic identification. The multi-episode video may a TV drama with multiple episodes, a movie with parts, a TV program with multiple episodes, etc.

For example, a Chinese TV drama “Demi-Gods and Semi-Devils” has 38 episodes, which all correspond to the same characteristic identification, for example, the same characteristic identification is “1”. For example, a variety program “Kangxi Lai le” is divided into more than 1000 episodes which correspond to the same characteristic identification, for example, the same characteristic identification is “2”.

In addition, the type of the video selected by a user may be any of type of online video, offline video, and live video.

In step 202, m videos with the same characteristic identification, which includes at least tow types of videos, are determined, where m≧2.

After acquiring the characteristic identification of the arbitrary video, the video player determines m videos with the same characteristic identification of the at least two types of videos. Herein, the at least two types include any two or all of types of online video, offline video, and live video.

The m videos may include a video selected by a user and/or a video associated with the video selected by the user. As for a multi-episode video, an associated video of any episode may be the episodes in the multiple-episode video.

In addition, since offline resources of a video are usually stored locally, and online resources and live resources are usually stored in a server, the video player may determine the at least two types of m videos with the same characteristics identification locally and/or from the server.

For online videos, the server accesses online resources from various online video providers in advance, and then assigns characteristic identifications to online videos corresponding to respective online resources, wherein different programs correspond to the different characteristics identifications. For offline videos, since offline videos are usually obtained by downloading online videos from the server or from the online video providers via the server and then storing the downloaded online videos locally, the characteristic identification corresponding to each offline videos is the characteristic identification assigned to the online video corresponding to the offline video by the server. For live videos, the server acquires live schedules from broadcast content providers in advance, and thereafter performs a match with an online video by means of name matching, keyword matching, content matching, and so on. If the match is successful, the server assigns a characteristics identification of the online video to a live video that successfully matches the online video.

Therefore, when the video player needs to determine online video and/or live video with the same characteristics identification from the server, the video player sends a characteristics identification of a video selected by a user to the server. After receiving the characteristics identification, the server determines online video and/or live video having the characteristics identification according to a pre-stored corresponding correlation between different online videos and different characteristics identifications and/or a pre-stored corresponding correlation between different live videos and different characteristics identifications, and feeds back a determination result to the video player. The video player obtains at the least two types of m videos, which includes any two or all of types of online video, offline video, and live video, by integrating the determination results received from the server with the determination results acquired locally.

In step 203, a list of the selection of video is provided according to the m videos.

The video player provides the list of the selection of video according to the m videos when determining the at least two types of m videos with the same characteristics identification.

In the m videos, there may be a repetition among the different types of videos, for example, the TV drama “Demi-Gods and Semi-Devils” may correspond to 37 online videos, 10 offline videos and 2 live videos. The 37 online videos respectively correspond to 1^{st} to 37^{th} episodes, the 10 offline videos respectively correspond to 11th to 20th episodes, and the two live videos respectively correspond to the thirteenth episode broadcasted on a TV channel A and the thirty-eighth episode to be broadcasted on a TV channel B. Therefore, the video player removes the repetition among the m videos and then provides a corresponding playlist.

In an embodiment, the step may include the following sub-steps.

In a first sub-step, episode identifications of respective videos are acquired.

The video player acquires the episode identifications corresponding to the m videos. Herein, the episode identifications identify different episodes corresponding to the same program. For a multi-episode video, different episodes correspond to different episode identifications.

For example, the episode identifications corresponding to 38 episodes of the TV drama “Demi-Gods and Semi-Devils” are respectively “1” to “38”.

In a second sub-step, n videos are obtained by removing duplicates with regard to the m videos according to the episode identifications, where 1≦n≦m.

In a first possible implementation, when the m videos include a online videos and b offline videos, n videos are obtained by removing the online videos with the same episode identification as that of the offline videos, where a, b≧1.

An online video often contains relatively complete episodes. An offline video is usually a part of or all of an online video because the offline video is obtained by downloading the online video and stored it locally. On the basis of an online video, a video player remove the online video with the same episode identification as an offline video and keeps the offline video, whereby flow (or traffic) resources may be saved during video play while the choppy phenomena during streaming of video may be effectively avoided.

In a second possible implementation, when m videos include c online videos and d live videos, n videos are obtained by removing the live videos with the same episode identification as that of the online videos, where c, d≧1.

Since the Internet or live television has timelines, the live video usually contains episodes which are not contained in an online video and an offline video. However, the live video has poor selectivity because the live video is provided by the broadcast content providers and the playing of the live video is controlled so that a user cannot select a played episode according to his/her own time or preference. Therefore, live videos may be used as a good supplement to an online video and/or an offline video. On the basis of the online video, the video player removes the live video with the same episode identification as that of the online video and keeps the live video with the different episode identifications from the online video, whereby the selectivity may be guaranteed during video play while the user can view the latest and most complete episodes.

In a third possible implementation, when m videos include e offline videos and f live videos, n videos are obtained by removing the live videos with the same episode identification as that of the offline videos, where e, f≧1.

The third possible implementation can refer to the above second possible implementation, which will be not repeated herein.

In a fourth possible implementation, when m videos include g online videos, h offline videos, and i live videos, n videos are obtained by removing the online videos with the same episode identification as that of the offline videos and removing the live videos with the same episode identification as that of the online videos or the offline videos, where g, h, and i≧1. The fourth possible implementation can refer to the above first and second possible implementations, which will be not repeated herein.

Still taking the TV drama “Demi-Gods and Semi-Devils” for example, for the above 37 online videos, 10 offline videos and 2 live videos, a process of removing repetition performed by the video player may be as follows. Firstly, 27 online videos (including first to tenth episodes, as well as twenty-first episode and thirty-seventh episode), 10 offline videos (including eleventh to twentieth episodes) and 2 live videos (including a thirteenth episode being broadcasted on a TV channel A and a thirty-eighth episode to be broadcasted on a TV channel B) are obtained by removing the online video with the same episode identification as that of the 10 offline videos. Thereafter, the live video with the same episode identification as that of the offline videos or the online videos is removed, that is, the thirteenth episode being broadcasted on the TV channel A is removed, and as a result, the 27 online videos (including first to tenth episodes, as well as twenty-first episode and thirty-seventh episode), 10 offline videos (including eleventh to twentieth episodes) and one live video (the thirty-eighth episode to be broadcasted on the TV channel B) are obtained.

In a third sub-step, a list of the selection of video corresponding to the n videos is provided.

In a first possible implementation, when the n videos includes at least one online video, for each online video, at least one online play address corresponding to the online video is acquired, and the list of the selection of video is provided according to the at least one online play address.

For the same online video, it may correspond to one or more online play addresses. For example, a first episode in the TV drama “Demi-Gods and Semi-Devils” corresponds to several online play addresses from a number of different video websites. The video player may perform the following two possible processes after acquiring at least one online play address of an online video.

Firstly, an online play address is selected from at least one online play address according to a first predetermined condition which includes any of the highest definition, the highest resolution or the lowest bandwidth utilization of online resources corresponding to the online play address, and a list of the selection of video containing the online resources corresponding to the online play address is provided.

Different online resources of the same online video may have differences in definition, resolution and network bandwidth utilization during playing. The video player may select the online play address from at least one online play addresses based on the above differences, wherein the online resource corresponding to the selected online play address has the highest definition, or the highest resolution, or the lowest bandwidth utilization. Then the video player displays the online resource corresponding to the selected online play address in the list of the selection of video for the user to select, thereby providing better user viewing experience.

Secondly, a list of the selection of video containing at least one online resource corresponding to at least one online play address is provided.

The video player may also display all of a plurality of online resources in the list of the selection of video so that the user may select the preferable online resources to play from the list.

In a second possible implementation, when the n videos include at least one offline video, for each offline video, at least one offline play address corresponding to the offline video is acquired, and the list of the selection of video is provided according to the at least one offline play address.

For the same offline video, it may correspond to one or more offline play address. For example, an eleventh episode in the TV drama “Demi-Gods and Semi-Devils” may correspond to several offline play addresses of different video formats or different files. The video player may perform the following two possible processes after acquiring at least one offline play address of an offline video.

Firstly, an offline play address is selected from at least one offline play address according to a second predetermined condition which includes any of the highest definition or the highest resolution of offline resources corresponding to the offline play address, and a list of the selection of video containing the offline resources corresponding to the offline play address is provided.

Secondly, a list of the selection of video containing at least one offline resource corresponding to at least one offline play address is provided.

The two processes are the same or similar to the two processes in the online video, which will not be repeated herein.

In a third possible implementation, when the n videos include at least one live video, for each live video, at least one broadcast channel corresponding to the live video is acquired, and the list of the selection of video is provided according to the at least one broadcast channel.

For the same live video, it may correspond to one or more broadcast channels. For example, the thirty-eighth episode “Demi-Gods and Semi-Devils” may correspond to several different TV broadcast channels. The video player may perform the following process in the following steps, after acquiring the at least one broadcast channel corresponding to an arbitrary live video.

In step 1, broadcast times of respective broadcast channels are acquired.

Different broadcast channels have different live schedules including a schedule of live video, a schedule of broadcast time of respective live videos, and so on. For the same live video, the video player acquires the broadcast times of the live video on different broadcast channels.

In step 2, live broadcast channels and/or a soonest broadcast channel to be on live is selected according to the broadcast time.

In addition, when there are a plurality of broadcast channels being on live, the plurality of broadcast channels being on live may be retained at the same time, so that a user may select a broadcast channel to be viewed from the broadcast channels; Similarly, when there are a plurality of broadcast channels to be on live, the plurality of the soonest broadcast channels to be on live may be retained at the same time, so that a user may select a broadcast channel to be viewed from the broadcast channels.

In step 3, the list of the selection of video containing the live broadcast channels and/or the soonest broadcast channel to be on live is provided.

The video player displays the live broadcast channels and/or the soonest broadcast channel to be on live in the list of the selection of video, so that a user may select a broadcast channel to be viewed from the broadcast channels.

Alternatively, when the list of the selection of video contains the soonest broadcast channel to be on live, the video player records the broadcast time of the soonest broadcast channel to be on live, and provide a subscription and/or reminder service according to the broadcast time. If a user sets the subscription regarding a certain live video on a certain broadcast channel, the video player sends a reminder notice to a user within a predetermined time before the live video is played, so as to inform the user that the subscripted live video is to be played.

Referring to FIG. 2B, it shows a view of an interface interaction related to the present embodiment. A user is viewing a first episode of the TV drama “Demi-Gods and Semi-Devils”, and a video player provides a list of the selection of video 21. The list of the selection of video 21 includes video resources or broadcast channels corresponding to various types of videos such as an online video 22, an offline video 23 and a live video 24, for a user to select.

It should be noted that the above steps 201 to 203 may be separately implemented by the video player, and may be also implemented through an interaction between the video player and the server. A suitable implementation manner may be selected according to practical application, and the embodiments of the present disclosure do not limit to this.

The video player may further perform the following steps after providing the list of the selection of video according to the m videos.

In step 204, a selection signal, which controls the list of the selection of video, is acquired.

The user may select an arbitrary video to play in the selection list provided by the video player, and correspondingly, the video player acquires the selection signal and generated by triggering of the user.

In step 205, a type of video corresponding to the selection signal is acquired.

The video player acquires the type of video corresponding to the selection signal, which includes any of type of online video, offline video, and live video.

In step 206, a corresponding play interface is displayed according to the type and the video is played.

The play interfaces corresponding to different types of videos may vary. For example, a play interface of an online video usually contains a progress control bar, a play/pause control, a next episode control and a volume control, etc. However, a play interface of a live video usually does not contain the progress control bar and the next episode control because the user is not allowed to control the play progress and play contents. Therefore, in order to further improve the user's experience of viewing the video, the video player may provide different play interfaces when playing different types of videos, or adaptively modify or adjust the play interface, thereby satisfying the user's basic operation while avoiding unnecessary troubles to the user.

Referring to FIG. 2B, when the video player plays a first episode of the TV drama “Demi-Gods and Semi-Devils”, since the first episode of the TV drama “Demi-Gods and Semi-Devils” is an online video, a displayed play interface may include a progress control bar 26, a play/pause control 27, a next episode control 28 and a volume control 29. When a user triggers to select a “TV channel A” 25 in the list of the selection of video 21, the video player begins to play a thirty-eighth episode of the TV drama “Demi-Gods and Semi-Devils”. Since the thirty-eighth episode of the TV drama “Demi-Gods and Semi-Devils” is a live video, the displayed play interface may only include the play/pause control 27 and the volume control 29.

Accordingly, in the method for providing the selection of video, by acquiring the characteristic identification of the arbitrary video, determining the m videos with the same characteristic identification of the at least two types of videos, and providing the list of the selection of video according to the m videos, where the at least two types including any two or all of online video, offline video, and live video, problems in the related art, that playing and selecting of only a single type of multi-episode video, switching between different types of videos requiring a large amounts of additional operations and influencing of video fluency when a user views the video, may be solved. It can be realized that in the list of the selection of video, the function of selecting episodes of the at least two types of videos including online video, offline video and live video, may be provided, so that switching and selecting between different types of videos may become simpler and more convenient, thereby improving video fluency when a user views the video.

In addition, the method for providing the selection of video provided by the embodiments may further remove the repeated part among the acquired different types of videos according to the episode identification of respective videos, thereby avoiding the unnecessary troubles when the user selects episodes and improving efficiency of selecting episodes. At the same time, according to different characteristics of the different types of videos, on basis of online videos, the video player may remove online videos with the same episode identification as of the offline videos and retains the offline videos, thereby saving flow resources during the playing while avoiding choppy phenomena during the streaming of online video, and, the video player may remove live videos with the same episode identification as the online videos and retains the offline videos with the different episode identification from the online videos. On the basis of online videos, the video player removes live videos with the same episode identification as that of the online videos and retains the live videos with the different episode identifications from the online videos, whereby the selectivity may be guaranteed during video play while the user can view the latest and most complete episodes.

In addition, the method for providing a selection of video provided by the embodiments may further provide different play interfaces regarding different types of videos, thereby satisfying the user's basic operation while avoiding unnecessary troubles to the user and further improving the user's experience when viewing a video.

Hereafter, embodiments of an apparatus of the present disclosure will be described and the embodiments of the apparatus may be used for implementing the embodiments of the method of the present disclosure. The details, which are not disclosed in the embodiments of the apparatus of the present disclosure, may refer to the embodiments of the method of the present disclosure.

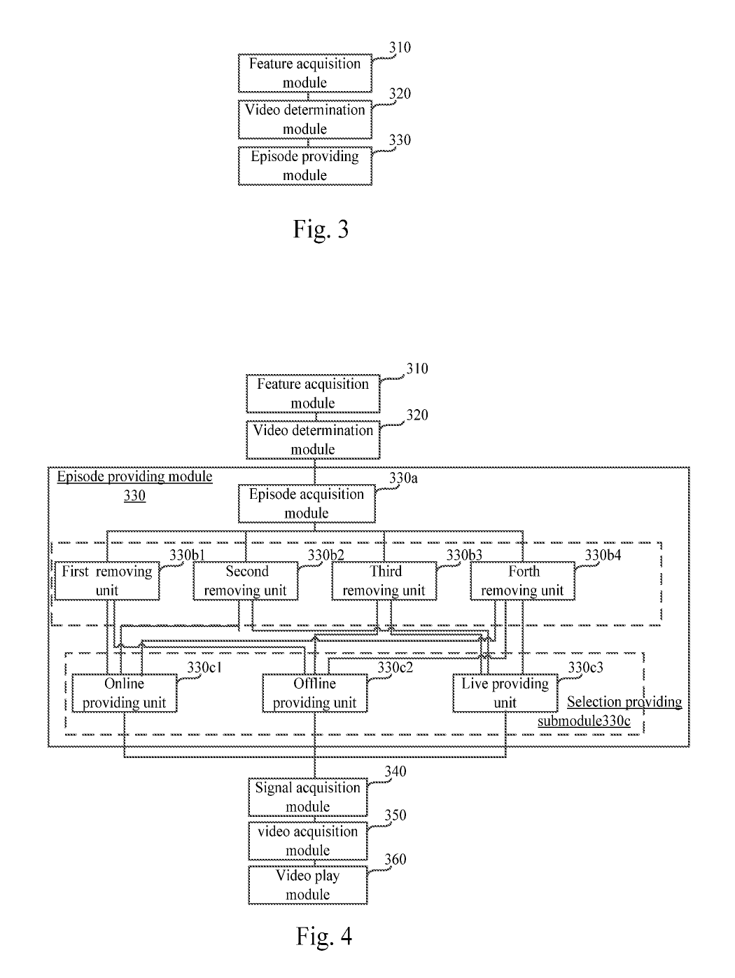

FIG. 3 is a block diagram of an apparatus for providing a selection of video according to an exemplary embodiment. The apparatus for providing the selection of video may be implemented as a part of or all of a video player by software, hardware or the combination thereof. The apparatus for providing the selection of video may include a feature acquisition module 310, a video determination module 320, and an episode providing module 330.

The feature acquisition module 310 is configured to acquire a characteristic identification of an arbitrary video.

The video determination module 320 is configured to determine m videos with the same characteristic identification, which includes at least two types of videos, where m≧2, and the at least two types of videos include any two or all types of online video, offline video, and live video.

The episode providing module 330 is configured to provide a list of the selection of video according to the m videos.

Accordingly, in the apparatus for providing a selection of video, by acquiring the characteristic identification of the arbitrary video, determining the m videos with the same characteristic identification of the at least two types of videos, and providing the list of the selection of video according to the m videos, where the at least two types including any two or all of online video, offline video, and live video, problems in the related art, that playing and selecting of only a single type of multi-episode video, switching between different types of videos requiring a large amounts of additional operations and influencing of video fluency when a user views the video, may be solved. It can be realized that in the list of the selection of video, the function of selecting episodes of the at least two types of videos including online video, offline video and live video, may be provided, so that switching and selecting between different types of videos may become simpler and more convenient, thereby improving video fluency when a user views the video.

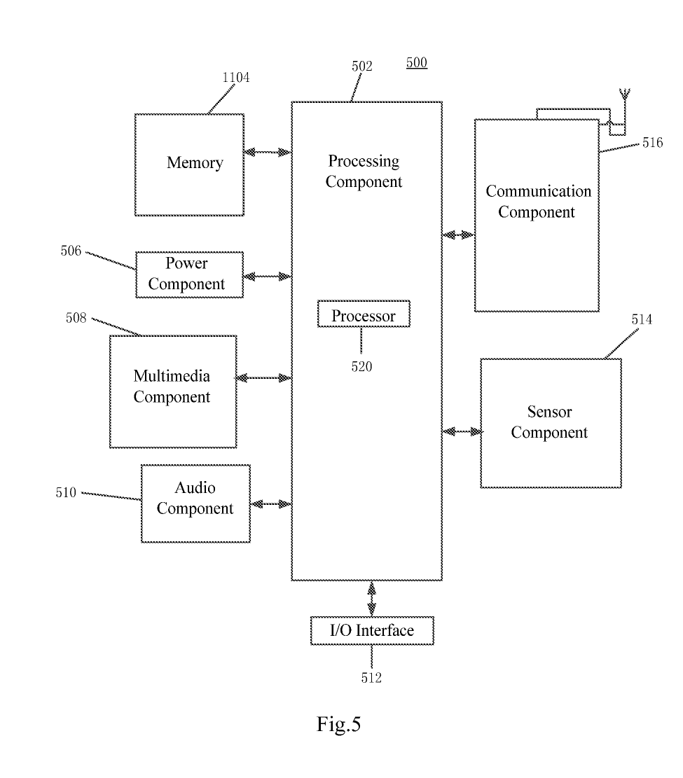

FIG. 4 is a block diagram of another apparatus for providing a selection of video according to an exemplary embodiment. The apparatus for providing the selection of video may be implemented as a part of or all of a video player by software, hardware or the combination thereof. The apparatus for providing the selection of video may include a feature acquisition module 310, a video determination module 320, and an episode providing module 330.

The feature acquisition module 310 is configured to acquire a characteristic identification of an arbitrary video.

The video determination module 320 is configured to determine m videos with the same characteristic identification, which includes at least two types of videos, where m≧2 and the at least two types of videos includes any two or all types of online video, offline video, and live video.

The episode providing module 330 is configured to provide a list of the selection of video according to the m videos.

In an embodiment, the episode providing module 330 includes an episode acquisition module 330a, a video removing sub-module 330b, and an episode-selection providing sub-module 330c.

The episode acquisition module 330a is configured to acquire episode identifications of respective videos.

The video removing sub-module 330b is configured to obtain n videos by removing duplicates with regard to the m videos according to the episode identifications, where 1≦n≦m.

In an embodiment, the video removing sub-module 330b includes a first removing unit 330b1, or a second removing unit 330b2, or a third removing unit 330b3, or a fourth removing unit 330b4.

The first removing unit 330b1 is configured to, when the m videos comprises a online videos and b offline videos, obtain the n videos by removing online video with the same episode identification as that of the offline videos, where a, b≧1.

The second removing unit 330b2 is configured to, when the m videos comprises c online videos and d live videos, obtain the n videos by removing live video with the same episode identification as that of the online videos, where c, d 1.

The third removing unit 330b3 is configured to, when the m videos comprises e offline videos and f live videos, obtain the n videos by removing live video with the same episode identification as that of the offline videos, where e, f≧1.

The fourth removing unit 330b4 is configured to, when the m videos comprises g online videos, h offline videos and i live videos, obtain the n videos by removing online video with the same episode identification as that of the offline videos and removing live video with the same episode identification as that of the offline videos or the online videos, where g, h, i≧1.

The episode-selection providing sub-module 330 is configured to provide a list of the selection of video corresponding to the n videos.

In an embodiment, the episode-selection providing sub-module 330c includes an online providing unit 330c1, an offline providing unit 330c2, and/or a live providing unit 330c3.

The online providing unit 330c1 is configured to, when the n videos comprises at least one online video, for each online video, acquire at least one online play address corresponding to the online video, and provide the list of the selection of video according to the at least online play address.

In an embodiment, the online providing unit 330c1 includes a selectively providing sub-unit or a directly providing sub-unit.

The selectively providing sub-unit is configured to select an online play address from the at least one online play address according to a predetermined condition which includes any of the highest definition, the highest resolution, or the lowest bandwidth utilization of the online resources corresponding to the online play address, and provide the list of the selection of video containing the online resource corresponding to the online play address.

The directly providing sub-unit is configured to provide a list of the selection of video containing at least one online resource corresponding to the at least one online play address.

The offline providing unit 330c2 is configured to, when the n videos comprises at least one offline video, for each offline video, acquire at least one offline play address corresponding to the offline video, and provide the list of the selection of video according to the at least one offline play address.

In an embodiment, the offline providing unit 330c2 includes a selectively providing sub-unit, or a wholly providing sub-unit.

The selectively providing sub-unit is configured to select an offline play address from the at least one offline play address according to a predetermined condition which includes any of the highest definition, the highest resolution, or the lowest bandwidth utilization of the offline resources corresponding to the offline play address, and provide the list of the selection of video containing the offline resource corresponding to the offline play address.

The wholly providing sub-unit is configured to provide the list of the selection of video containing the offline resource corresponding to the offline play address.

The live providing unit 330c3 is configured for, when the n videos comprises at least one live video, for each live video, acquiring at least one broadcast channel corresponding to the live video, and providing the list of the selection of video according to the at least one broadcast channel.

In an embodiment, the live providing unit 330c3 includes a time acquisition sub-unit, a live selection sub-unit, and a live providing sub-unit.

The time acquisition sub-unit is configured to acquire broadcast times of the respective broadcast channels.

The live selection sub-unit is configured to select a live broadcast channel and/or a soonest broadcast channel to be on live according to the broadcast time.

The live providing sub-unit is configured to provide the list of the selection of video containing the live broadcast channel and/or the soonest broadcast channel to be on live.

In an embodiment, the live providing unit 330c3 further includes a time record sub-unit and a server providing sub-unit.

The time record sub-unit is configured to record a broadcast time of the soonest broadcast channel to be on live when the list of the selection of video contains the soonest broadcast channel to be on live.

The server providing sub-unit is configured to provide a subscription and/or reminder service according to the broadcast time.

In an embodiment, the apparatus further includes:

A signal acquisition module 340 is configured to acquire a selection signal, which controls the list of the selection of video.

A video acquisition module 350 is configured to acquire the type of video corresponding to the selection signal.

A video play module 360 is configured to display a corresponding play interface according to the type and play the video.

Accordingly, in the apparatus for providing the selection of video, by acquiring the characteristic identification of the arbitrary video, determining the m videos with the same characteristic identification of the at least two types of videos, and providing the list of the selection of video according to the m videos, where the at least two types including any two or all of online video, offline video, and live video, problems in the related art, that playing and selecting of only a single type of multi-episode video, switching between different types of videos requiring a large amounts of additional operations and influencing of video fluency when a user views the video, may be solved. It can be realized that in the list of the selection of video, the function of selecting episodes of the at least two types of videos including online video, offline video and live video, may be provided, so that switching and selecting between different types of videos may become simpler and more convenient, thereby improving video fluency when a user views the video.

In addition, the apparatus for providing the selection of video provided by the embodiments may further remove the repeated part among the acquired different types of videos according to the episode identification of respective videos, thereby avoiding the unnecessary troubles when the user selects episodes and improving efficiency of selecting episodes. At the same time, according to different characteristics of the different types of videos, on basis of online videos, the video player may remove online videos with the same episode identification as of the offline videos and retains the offline videos, thereby saving flow resources during the playing while avoiding choppy phenomena during the streaming of online video, and, the video player may remove live videos with the same episode identification as the online videos and retains the offline videos with the different episode identification from the online videos. On the basis of online videos, the video player removes live videos with the same episode identification as that of the online videos and retains the live videos with the different episode identifications from the online videos, whereby the selectivity may be guaranteed during video play while the user can view the latest and most complete episodes.

In addition, the apparatus for providing the selection of video provided by the embodiments may further provide different play interfaces regarding the different types of videos, thereby satisfying the user's basic operation while avoiding the unnecessary troubles to the user and further improving the user's experience when viewing a video.

In the apparatus in the above embodiments, the implementation operations of respective modules have been described in detail in the method of the embodiments, which will be not described in detail herein.

FIG. 5 is a block diagram of a device 500 for providing a selection of video according to an exemplary embodiment. For example, the device 500 may be a mobile phone, a computer, a digital broadcast terminal, a message sending and receiving device, a game console, a tablet device, a medical equipment, a fitness equipment, personal digital assistants, etc.

Referring to FIG. 5, the device 500 may include one or more components: a processor component 502, a memory 504, a power component 506, a multimedia component 508, an audio component 510, an input/output (I/O) interface 512, a sensor component 514, and a communication component 516.

The processor component 502 typically controls overall operations of the device 500, such as the operations associated with display, telephone calls, data communications, camera operations, and recording operations. The processor component 502 may include one or more processors 520 to execute instructions to perform all or part of the steps in the above described methods. Moreover, the processor component 502 may include one or more modules which facilitate the interaction between the processor component 502 and other components. For instance, the processor component 502 may include a multimedia module to facilitate the interaction between the multimedia component 508 and the processor component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (“MIC”) configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processor component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 520 in the device 500, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium, when instructions stored in the storage medium are executed by a processor of the device 500, the device 500 may be caused to be capable of performing a method for providing the selection of video as shown in FIG. 1 and FIG. 2A.

The person skilled in the art may easily anticipate other solutions after consideration of the above description and implementation of the disclosure. The disclosure intends to cover any variation, usage or modification, which follow a general principle of the disclosure and includes common knowledge or usual technical means in the art. The description and embodiments are exemplary and the scope and principle of the disclosure are limited by the appending claims.

It will be appreciated that the above embodiments are exemplary and the disclosure is not limited thereto, and that various modifications and changes can be made without departing from the scope thereof. It is intended that the scope of the invention only be limited by the appended claims.

What is claimed is:

1. A method of providing a selection of video, comprising:
for an arbitrary video, acquiring a characteristic identification of the video;
determining m videos with the same characteristic identification, which includes at least two types of videos, where m≧2, wherein the at least two types of videos comprise any two or all of types of online video, offline video, and live video; and
providing a list of the selection of video according to the m videos.

2. The method of claim 1, wherein providing the list of the selection of video according to the m videos comprises:
acquiring an episode identification for each respective video;
obtaining n videos by removing duplicates with regard to the m videos according to the episode identifications, where 1≦n≦m; and
providing a list of the selection of video corresponding to the n videos.

3. The method of claim 2, wherein obtaining the n videos by removing duplicates with regard to the m videos according to the episode identifications comprises:
obtaining the n videos by removing online videos with the same episode identification as that of offline videos, when the m videos comprises a online videos and b offline videos, where a, b≧1.

4. The method of claim 2, wherein obtaining the n videos by removing duplicates with regard to the m videos according to the episode identifications comprises:
obtaining the n videos by removing live videos with the same episode identification as that of online videos, when the m videos comprises c online videos and d live videos, where c, d≧1.

5. The method of claim 2, wherein obtaining the n videos by removing duplicates with regard to the m videos according to the episode identifications comprises:
obtaining the n videos by removing live videos with the same episode identification as that of offline videos, when the m videos comprises e offline videos and f live videos, where e, f≧1.

6. The method of claim 2, wherein obtaining the n videos by removing duplicates with regard to the m videos according to the episode identifications comprises:
obtaining the n videos by removing online videos with the same episode identification as that of offline videos and removing live videos with the same episode identification as that of offline videos or online videos, when the m videos comprises g online videos, h offline videos and i live videos, where g, h, i≧1.

7. The method of claim 2, wherein providing the list of the selection of video corresponding to the n videos comprises:
when the n videos comprises at least one online video, for each online video, acquiring at least one online play address corresponding to the online video; and
providing the list of the selection of video according to the at least one online play address.

8. The method of claim 2, wherein providing the list of the selection of video corresponding to the n videos comprises:
when the n videos comprises at least one offline video, for each offline video, acquiring at least one offline play address corresponding to the offline video; and
providing the list of the selection of video according to the at least one offline play address.

9. The method of claim 2, wherein providing the list of the selection of video corresponding to the n videos comprises:
when the n videos comprises at least one live video, for each live video, acquiring at least one broadcast channel corresponding to the live video; and
providing the list of the selection of video according to the at least one broadcast channel.

10. The method of claim 7, wherein providing the list of the selection of video according to the at least one online play address comprises:
selecting an online play address from at least one online play address according to a predetermined condition which includes one of online resources corresponding to the online play address having any one of highest definition, highest resolution, or lowest bandwidth utilization; and
providing the list of the selection of video containing the online resource corresponding to the online play address.

11. The method of claim 7, wherein providing the list of the selection of video according to the at least one online play address comprises:
providing the list of the selection of video containing at least one online resource corresponding to the at least one online play address.

12. The method of claim 8, wherein providing the list of the selection of video according to the at least offline play address comprises:
selecting an offline play address from at least one offline play address according to a predetermined condition which includes one of offline resources corresponding to the offline play address having any one of highest definition or highest resolution; and
providing the list of the selection of video containing the offline resource corresponding to the offline play address.

13. The method of claim 8, wherein providing the list of the selection of video according to the at least offline play address comprises:
providing the list of the selection of video containing at least one offline resource corresponding to the at least one offline play address.

14. The method of claim 9, wherein providing the list of the selection of video according to the at least live channel comprising:
acquiring broadcast times of the respective broadcast channels;
selecting a live broadcast channel and/or a soonest broadcast channel to be on live according to the broadcast times; and
providing the list of the selection of video containing the live broadcast and/or the soonest broadcast channel to be on live.

15. The method of claim 14, wherein, the method further comprises:
recording a broadcast time of the soonest broadcast channel to be on live when the list of the selection of video contains the soonest broadcast channel to be on live; and
providing a subscription and/or reminder service according to the broadcast time.

16. The method of claim 2, wherein, the method further comprises:
acquiring a selection signal which controls the list of the selection of video;
acquiring a type of a video corresponding to the selection signal;
displaying a corresponding play interface according to the type; and
playing the video.

17. A device of providing a selection of video, comprising:
a processor;
a memory for storing instructions executable by the processor;
wherein, the processor is configured to perform:
for an arbitrary video, acquiring a characteristic identification of the video;
determining m videos with the same characteristic identification, which includes at least two types of videos, where m≧2, wherein the at least two types of videos comprise any two or all of types of online video, offline video, and live video; and
providing a list of the selection of video according to the m videos.

18. The device of claim 17, wherein providing the list of the selection of video according to the m videos comprises:
acquiring an episode identification for each respective video;
obtaining n videos by removing duplicates with regard to the m videos according to the episode identifications, where 1≦n≦m; and
providing a list of the selection of video corresponding to the n videos.

19. A non-transitory computer-readable storage medium having stored therein instructions that, when executed by a processor of a device, causes the device to perform a method of providing a selection of video, the method comprising:
for an arbitrary video, acquiring a characteristic identification of the video;
determining m videos with the same characteristic identification, which includes at least two types of videos, where m≧2, wherein the at least two types of videos comprise any two or all of types of online video, offline video, and live video; and
providing a list of the selection of video according to the m videos.

20. The non-transitory computer-readable storage medium of claim 19, wherein providing the list of the selection of video according to the m videos comprises:
acquiring episode identifications of the respective videos;
obtaining n videos by removing duplicates with regard to the m videos according to the episode identifications, where 1≦n≦m; and
providing a list of the selection of video corresponding to the n videos.
